(19) United States
(12) Patent Application Publication
(10) Pub. No.: US 2022/0121966 A1
(43) Pub. Date: Apr. 21, 2022

(54) KNOWLEDGE GRAPH EMBEDDING REPRESENTATION METHOD, AND RELATED DEVICE

(71) Applicant: HUAWEI TECHNOLOGIES CO., LTD., Shenzhen (CN)

(72) Inventors: Danping WU, Hangzhou (CN); Xiuxing LI, Beijing (CN); Shuo GUO, Hangzhou (CN); Dong LIU, Shenzhen (CN); Yantao JIA, Beijing (CN); Jianyong WANG, Beijing (CN)

(21) Appl. No.: 17/563,411

(22) Filed: Dec. 28, 2021

Related U.S. Application Data
(63) Continuation of application No. PCT/CN2020/096898, filed on Jun. 18, 2020.

(30) Foreign Application Priority Data
Jun. 29, 2019 (CN) 201910583845.0

(51) Int. Cl. G06N 5/02; G06F 40/30; G06F 40/295

(52) U.S. Cl. CPC G06N 5/022; G06F 40/295; G06F 40/30

(57) ABSTRACT

A knowledge graph embedding representation method and a related device are disclosed. The method includes: obtaining, from a preset knowledge base, N related entities of each entity in M entities of a target knowledge graph and K concepts corresponding to each of the N related entities, determining a semantic correlation between each entity and each of the N related entities of the entity, determining a first entity embedding representation of each of the N related entities based on the corresponding K concepts, modeling, based on the first entity embedding representation and the semantic correlation, an entity/relationship embedding representation, and training a model according to an attention mechanism and a preset model training method, to obtain the entity/relationship embedding representation.

### CROSS-REFERENCE TO RELATED APPLICATIONS

This application is a continuation of International Application No. PCT/CN2020/096898, filed on Jun. 18, 2020, which claims priority to Chinese Patent Application No. 201910583845.0, filed on Jun. 29, 2019. The disclosures of the aforementioned applications are hereby incorporated by reference in their entireties.

### TECHNICAL FIELD

This application relates to the field of information processing, and in particular, to a knowledge graph embedding representation method and a related device.

### BACKGROUND

A knowledge graph is a highly structured information representation form, and may be used to describe a relationship between various entities in the real world. The entity is an object that exists objectively and can be distinguished from each other, for example, a person name, a place name, a movie name, and the like. A typical knowledge graph consists of a large number of triplets (head entity, relation, and tail entity). Each triplet represents a fact. As shown in FIG. 1, fact triplets included in a knowledge graph includes [Jay Zhou, blood type, O type], [Jay Zhou, nationality, Han nationality], [the unspeakable secret, producer, Jiang Zhiqiang], and the like. Currently, there are a plurality of large-scale and open-domain knowledge graphs, such as Freebase and WordNet, but the knowledge graphs are far from being complete. A completeness of a knowledge graph determines application value of the knowledge graph. To improve the completeness of the knowledge graph, an existing knowledge graph embedding representation may be first performed, and then the knowledge graph is completed based on an entity/relationship embedding representation. However, an existing knowledge graph embedding representation and completion method is limited by a sparse graph structure, and an external information feature used is easily affected by a scale of a text corpus. As a result, an implemented complementary effect of a knowledge graph is not ideal.

### SUMMARY

Embodiments of this application provide a knowledge graph embedding representation method and a related device, to implement semantic extension of an entity, to improve a representation capability in a complex relationship between entities in a knowledge graph, and improve accuracy and comprehensiveness of knowledge graph completion.

According to a first aspect, an embodiment of this application provides a knowledge graph completion method, including: first obtaining M entities in a target knowledge graph, where the M entities include an entity 1, an entity 2, . . . , and an entity M, and M is an integer greater than 1; obtaining, from a preset knowledge base, N related entities of an entity m in the M entities and K concepts corresponding to a related entity n in the N related entities, where the N related entities include a related entity 1, a related entity 2, . . . , and a related entity N, N and K are integers not less than 1, m=1, 2, 3, . . . , and M, n=1, 2, 3, . . . , and N, the entity m is semantically correlated with the N related entities, and the related entity n is semantically correlated with the K concepts; then determining a semantic correlation between each of the M entities and each of the N related entities of the entity m, and determining a first entity embedding representation of each of the N related entities based on corresponding K concepts; modeling, based on the first entity embedding representation and the semantic correlation, an embedding representation of the M entities and an embedding representation of an entity relationship between the M entities, to obtain an embedding representation model; and training the embedding representation model to obtain a second entity embedding representation of each entity and a relationship embedding representation of the entity relationship. A two-layer information fusion mechanism, for example, entity—related entity—related entity of a related entity, is used to model an entity/relationship embedding representation in the knowledge graph. This can effectively implement semantic extension of an entity, and improve knowledge graph completion effect.

In an example embodiment, vectorization processing may be performed on each concept in the K concepts corresponding to the related entity n, to obtain a word vector of each concept. Average summation is performed on word vectors of the K concepts corresponding to the related entity n, to obtain a first entity embedding representation of the related entity n, where n=1, 2, 3, . . . , and N. Using a word vector of a concept to represent a related entity is equivalent to performing first-layer information fusion from the concept to the related entity, to prepare for second-layer information fusion from the related entity n to the entity m.

In another example embodiment, a unary text embedding representation corresponding to each entity may be determined based on the semantic correlation and a first entity embedding representation of the N related entities. A common related entity of every two entities in the M entities is determined based on the N related entities. A binary text embedding representation corresponding to the every two entities is determined based on the semantic correlation and a first entity embedding representation of the common related entity. The embedding representation model is established based on the unary text embedding representation and the binary text embedding representation. The unary text embedding representation is equivalent to a vectorized representation of content of an aligned text of the entity m, which is used to capture background information of the entity m. The binary text embedding representation is equivalent to a vectorized representation of a content intersection of aligned texts corresponding to two entities. The binary text embedding representation changes with a change in an entity, and is used to model a relationship, to implement embedding representation of a one-to-many, many-to-one, and many-to-many complex relationship.

In another example embodiment, the unary text embedding representation and the binary text embedding representation may be mapped to a same vector space to obtain a semantically enhanced unary text embedding representation and a semantically enhanced binary text embedding representation. The embedding representation model is established based on the semantically enhanced unary text embedding representation and the semantically enhanced binary text embedding representation. Because the unary text embedding representation corresponding to a single entity and the binary text embedding representation corresponding to two entities are usually not in a same vector space. This increases calculation complexity. To resolve this problem, the unary text embedding representation and the binary text embedding representation may be mapped to the same vector space.

In another example embodiment, the semantic correlation may be used as a first weight coefficient of each of the related entities. In addition, weighted summation is performed, based on the first weight coefficient, on the first entity embedding representation of the N related entities, to obtain the unary text embedding representation. The semantic correlation can reflect a degree of association between an entity and a related entity to some extent. Therefore, using the semantic correlation as a weight coefficient can improve accuracy of a semantic expression tendency of an entity after information fusion.

In another example embodiment, the common related entity and a minimum semantic correlation of semantic correlations of every two entities are used as a second weight coefficient of the common related entity. Weighted summation is performed, based on the second weight coefficient, on the first entity embedding representation of the common related entity, to obtain the binary text embedding representation. The binary text embedding representation is equivalent to a vectorized representation of a content intersection of aligned texts corresponding to two entities. The minimum semantic correlation can improve accuracy of the content intersection, and ensure validity and accuracy of the binary text embedding representation.

In another example embodiment, a loss function of the embedding representation model is determined. The embedding representation model is trained, according to a preset training method, to minimize a function value of the loss function, to obtain the second entity embedding representation and the relationship embedding representation. The loss function indicates a Euclidean distance between a tail entity and a sum vector that is of a head entity and a relationship of a known fact triple. Therefore, minimizing the function value of the loss function allows the sum vector to be closest to the tail entity, to implement a TransE framework-based knowledge graph embedding representation.

In another example embodiment, the function value of the loss function is associated with an embedding representation of each entity, an embedding representation of the entity relationship, and the unary text embedding representation. Therefore, the embedding representation of each entity and the embedding representation of the entity relationship may be first initialized to obtain an initial entity embedding representation and an initial relationship embedding representation. Then, the first weight coefficient is updated according to an attention mechanism to update the unary text embedding representation, and the initial entity embedding representation and the initial relationship embedding representation are iteratively updated according to the training method. The attention mechanism may be used to continuously learn a weight coefficient of a related entity in a unary text embedding representation, to continuously improve accuracy of captured background content of each entity. Therefore, updating the initial entity embedding representation and the initial relationship embedding representation based on an updated unary text embedding representation can effectively improve benefits of a finally obtained entity embedding representation and relationship embedding representation for knowledge graph completion.

In another example embodiment, the target knowledge graph includes a known fact triplet, and the known fact triplet includes two entities in the M entities and an entity relationship. Therefore, after the second entity embedding representation of each entity and the relationship embedding representation of the entity relationship are obtained, the entity relationship included in the known fact triplet may be replaced with another entity relationship between the N entities, or one entity included in the known fact triplet may be replaced with another entity in the N entities, to obtain a predicted fact triplet. A recommended score of the predicted fact triplet is determined based on a second entity embedding representation of an entity in the predicted fact triplet and a relationship embedding representation of the entity relationship. Then, the predicted fact triplet is added to the target knowledge graph based on the recommended score. The knowledge coverage of the target knowledge graph can be improved, to improve value of the knowledge graph.

According to a second aspect, an embodiment of this application provides a knowledge graph embedding representation apparatus. The knowledge graph embedding representation apparatus is configured to implement the methods and the functions that are performed by the knowledge graph embedding representation apparatus in the first aspect, and is implemented by hardware/software. The hardware/software of the knowledge graph embedding representation apparatus includes units corresponding to the foregoing functions.

According to a third aspect, an embodiment of this application provides a knowledge graph embedding representation device, including a processor, a memory, and a communications bus. The communications bus is configured to implement a connection and communication between the processor and the memory, and the processor executes a program stored in the memory to implement the steps in the knowledge graph embedding representation method provided in the first aspect.

In an example embodiment, the knowledge graph embedding representation device provided in this embodiment may include a corresponding module configured to perform behavior of a knowledge graph completion apparatus in the foregoing method design. The module may be software and/or hardware.

According to a fourth aspect, an embodiment of this application provides a computer-readable storage medium. The computer-readable storage medium stores an instruction, and when the instruction is run on a computer, the computer is enabled to perform the method in the foregoing aspects.

According to a fifth aspect, an embodiment of this application provides a computer program product including an instruction. When the computer program product is run on a computer, the computer is enabled to perform the method in the foregoing aspects.

### BRIEF DESCRIPTION OF DRAWINGS

To describe the technical solutions in the embodiments of this application or the prior art more clearly, the following briefly describes the accompanying drawings required for describing the embodiments.

FIG. 1 is a schematic structural diagram of a knowledge graph in the background part;

FIG. 2 is a schematic structural diagram of an application software system according to an embodiment of this application;

FIG. 3 is a schematic flowchart of a knowledge graph embedding representing method according to an embodiment of this application;

FIG. 4 is a schematic flowchart of a knowledge graph embedding representing method according to another embodiment of this application;

FIG. 5 is a schematic flowchart of a completion effect of a knowledge graph according to an embodiment of this application;

FIG. 6 is a schematic structural diagram of a knowledge graph embedding representing apparatus according to an embodiment of this application; and

FIG. 7 is a schematic structural diagram of a knowledge graph embedding representing device according to an embodiment of this application.

### DESCRIPTION OF EMBODIMENTS

The following describes the embodiments of this application with reference to the accompanying drawings in the embodiments of this application.

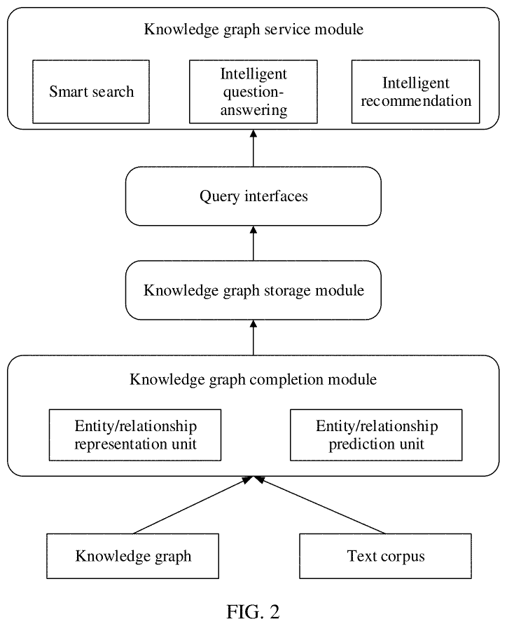

FIG. 2 is a schematic structural diagram of an application software system according to an embodiment of this application. As shown in the figure, the application software system includes a knowledge graph completion module, a knowledge graph storage module, a query interface, and a knowledge graph service module. The knowledge graph completion module may further include an entity/relationship embedding representation unit and an entity/relationship prediction unit. The knowledge graph service module may provide, to an external system, services such as intelligent search, intelligent question-answering, and intelligent recommendation based on the knowledge graph stored in the knowledge graph storage module. In the system, the knowledge graph completion module may receive a text corpus and a known knowledge graph that are input from the external system, and complete the known knowledge graph according to a preset knowledge graph completion method and the text corpus, that is, add a new fact triplet to the known knowledge graph. The entity/relationship embedding representation unit may embed and represent an entity and an entity relationship in the knowledge graph, where both the entity and the relationship in the knowledge graph are texts or other forms that cannot be operated. Embedding representation refers to mapping semantic information of each entity and each entity relationship to a multi-dimensional vector space, which is represented as a vector. The entity/relationship prediction unit may infer a new fact triplet based on an obtained vector, and add the new fact triplet to the known knowledge graph. The knowledge graph storage module may store the completed known knowledge graph. The knowledge graph service module may apply, by using the query interface, the knowledge graph stored in the knowledge graph storage module to tasks in various fields. For example, information that matches a keyword entered by a user is queried from a stored completed known knowledge graph, and is presented to the user.

Currently, the knowledge graph completion method used by the knowledge graph completion module may include: (1) a structure information-based method: infer a new triplet from an existing fact triplet in the knowledge graph, for example, a TransE model and a TransR model. In practice, it is found that the method is often prone to be limited by a sparse graph structure, and cannot effectively embed and represent complex entity relationship (one-to-many or many-to-one relationship) in the completed knowledge graph, resulting in poor completion effect of the knowledge graph. (2) An information fusion-based method: fuse external information (that is, a text corpus) to extract a new entity and a new fact triplet. However, this method usually uses only a feature of a co-occurrence word, and the feature is prone to be limited by a scale of the corpus, which leads to certain errors in a knowledge graph completion result. To resolve a problem that knowledge graph completion effect is not ideal, the embodiments of this application provide the following knowledge graph embedding representation method.

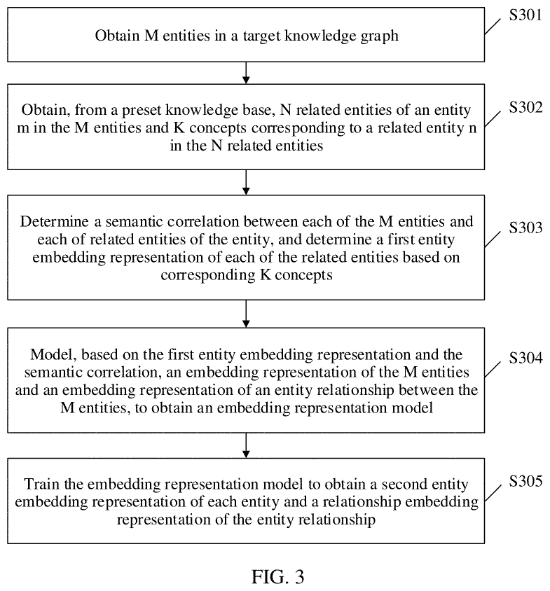

FIG. 3 is a schematic flowchart of a knowledge graph embedding representing method according to an embodiment of this application. The method includes but is not limited to the following steps.

S301: Obtain M entities in a target knowledge graph.

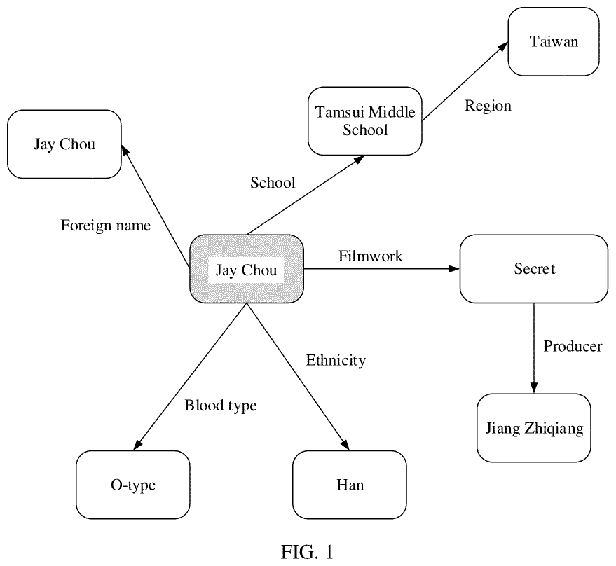

In a specific implementation, the knowledge graph may be considered as a network diagram including a plurality of nodes. The plurality of nodes may be connected to each other, each node represents one entity, and an edge connecting two nodes represents a relationship between two connected entities. M is an integer not less than 1, and the M entities include an entity 1, an entity 2, . . . , and an entity M. The target knowledge graph may be any knowledge graph that requires embedding representation and information completion. For example, as shown in FIG. 1, entities such as “Jay Chou”, “Tamsui Middle School”, “Taiwan”, and “Han nationality” may be obtained from the target knowledge graph.

S302: Obtain, from a preset knowledge base, N related entities of an entity m in the M entities and K concepts corresponding to a related entity n in the N related entities.

In a specific implementation, N and K are integers not less than 1, and the N related entities include a related entity 1, a related entity 2, . . . , and a related entity M, where m=1, 2, 3, . . . , M, and n=1, 2, 3, . . . , and N. The knowledge base contains a large number of texts and pages. First, each entity in the target knowledge graph may be automatically linked to a text in the knowledge base by using, but not limited to, an entity linking technology, and a related entity of the entity is obtained. For an entity in the target knowledge graph, the related entity is an entity semantically related to the entity, in other words, the entity is related to context of the entity. For example, “Zhang Yimou” and “The Flowers Of War”. The available entity link technology includes an AIDA technology, a Doctagger technology, and an LINDEN technology. Then, the related entity may be linked to a page in the knowledge base. After punctuations and stop words are removed from the page, concepts corresponding to the related entity may be obtained from the page. The concepts may be, but are not limited to, all concepts that are automatically identified on the page by using a wiki tool. Then, a person name and a place name are extracted from the identified concepts as the concepts corresponding to the related entity. For example, if the related entity is “David”, a corresponding page linked to “David” is usually a page that provides basic information about David. Information included on the page is that David's birthplace is Hawaii, USA, David's graduation institution is Harvard University, and David's wife is Michelle. In this way, the place names “USA”, “Hawaii” and “Harvard University”, and the person name “Michelle” can be extracted from the page as four concepts corresponding to the related entity “David”. In a field of knowledge base, a concept is a term that covers a slightly broader scope than an entity. In most cases, a concept may be directly used as an entity and an entity is directly used as a concept. Currently, there is no uniform criterion on whether and how to distinguish between a concept and an entity in different knowledge bases.

S303: Determine a semantic correlation between each of the M entities and each of the N related entities of the entity, and determine a first entity embedding representation of each of the N related entities based on corresponding K concepts.

In a specific implementation, on one hand, it may be first determined that an actual total quantity of the N related entities of an i^{th} entity eⁱ in the target knowledge graph is E₁, and an eⁱ actual total quantity of K concepts corresponding to a j^{th} related entity eⱼⁱ is E₂. Then, based on E₁ and E₂, a semantic correlation yᵢⱼ between the entity eⁱ and the related entity eⱼⁱ may be calculated according to formula (1).

$${y}_{ij} = 1 - \frac{log ( max ( {E}_{1} , {E}_{2} ) - log ( {E}_{1} ⋂ {E}_{2} ) )}{log ( W ) - log ( min ( {E}_{1} , {E}_{2} ) )} \qquad ( 1 )$$

W is a total quantity of entities included in the preset knowledge base. E₁∩E₂ indicates a quantity of entities and concepts with the same text content in E₁ related entities of eⁱ and E₂ concepts of eⱼⁱ.

For example, if eⁱ has three related entities of “China”, “Huaxia”, and “Ancient Civilization” and eⱼⁱ has a concept of “China”, then eⁱ and eⱼⁱ respectively have a related entity and concept whose text content is “China”. In other words, E₁∩E₂ is 1. min(a, b) indicates a minimum value of a and b, and max(a, b) indicates a maximum value of a and b.

It should also be noted that, in S302, R related entities of each entity may usually be obtained by using an entity linking technology, where R is greater than N. Therefore, the N related entities described above may be selected from the R related entities based on a semantic correlation. For example, the R related entities may be sorted in descending order of semantic correlations, and then the first N related entities are selected as the N related entities. All related entities whose semantic correlation is greater than a preset threshold in the R related entities may also be used as the N related entities.

On the other hand, vectorization processing may be performed on each of the K concepts by using a word vector generation model (for example, a word2vec model), to obtain a word vector of each concept. Then, average summation is performed on word vectors of all the concepts, and a result of the average summation is a first entity embedding representation of the related entity.

For example, a word vector set formed by word vectors of K concepts corresponding to eₘⁱ is d(eₘⁱ)={μ₁, μ₂, . . . , μ_{K}}, where μ is a G-dimensional row vector, and a size of G may be set based on an actual scenario and/or a scale of the knowledge graph. In this case, a first entity embedding representation xₘⁱ of eₘⁱ may be calculated according to formula (2).

$${x}_{m}^{i} = \frac{1}{K} {\sum }_{μ ∈ d ( {e}_{m}^{i} )} μ \qquad ( 2 )$$

S304: Model, based on the first entity embedding representation and the semantic correlation, an embedding representation of the M entities and an embedding representation of an entity relationship between the M entities, to obtain an embedding representation model.

In a specific implementation, an entity eⁱ in the target knowledge graph may be considered as a central entity, and M related entities of eⁱ are e₁ⁱ, e₂ⁱ, . . . , e_{M}ⁱ, and the first entity embedding representation of e₁ⁱ, e₂ⁱ, . . . , e_{M}ⁱ are x₁ⁱ, x₂ⁱ, . . . , x_{M}ⁱ respectively. Modeling steps for the embedding representation model include:

(1) Calculate, based on x₁ⁱ, x₂ⁱ, . . . , x_{M}ⁱ and a semantic correlation yᵢⱼ between each of the related entities and the central entity, a unary text embedding representation n(eⁱ) corresponding to the central entity eⁱ, where the semantic correlation may be used as a first weight coefficient of each of the related entities, and then weighted summation is performed on x₁ⁱ, x₂ⁱ, . . . , x_{M}ⁱ based on the first weight coefficient, to obtain

$$n ( {e}^{i} ) = \frac{1}{{\sum }_{j = 1}^{M} {y}_{ij}} {\sum }_{j = 1}^{M} {y}_{ij} {x}_{j}^{i} \qquad ( 3 )$$

A coefficient 1/Σⱼ₌₁^{M}yᵢⱼ in the foregoing formula is used to normalize the first weight coefficient. The unary text embedding representation may be considered as a vectored representation of text content to which the central entity eⁱ is linked, that is, the text in which the related entity is located.

(2) Determine, based on the N related entities, a common related entity of every two entities. The two entities may have one or more common related entities, or have no common related entity. For example, related entities of the entity “Zhang Yimou” include “Coming Home”, “Hero”, and “The Road Home”. Related entities of an entity “Gong Li” include “Coming Home” and “Farewell My Concubine”. In this way, a common related entity of “Zhang Yimou” and “Gong Li” is “Coming Home”. Then, the binary text embedding representation corresponding to every two entities is determined based on the semantic correlation between each of the every two entities and the common related entity, and the first entity embedding representation of the common related entity. The binary text embedding representation may be considered as a vectorized representation of a content intersection of text to which two central entities eⁱ are linked. The common related entity and a minimum semantic correlation of semantic correlations of every two entities are used as a second weight coefficient of the common related entity. Then, weighted summation is performed on the common related entity based on the second weight coefficient, and a result of the weighted summation is used as a binary text embedding representation. For example, the common related entity of the entity eⁱ and e^{j} includes e₁ⁱ, e₂ⁱ, . . . , eₘⁱ, and the corresponding binary text embedding representation n(eⁱ,e^{j}) of eⁱ and e^{j} is

$$n ( {e}^{i} , {e}^{i} ) = \frac{1}{Z} {\sum }_{k = 1}^{M} ( {y}_{ik} , {y}_{jk} ) {x}_{k}^{i} \qquad ( 4 )$$

yᵢₖ and yⱼₖ are respectively semantic correlations between related entities eₖⁱ and eⁱ, and between eₖⁱ and e^{j}. min(yᵢₖ,yⱼₖ) is the second weight coefficient of eₖⁱ, and 1/Z is used to normalize the second weight coefficient. Therefore,

$$Z = {\sum }_{k = 1}^{m} min ( {y}_{ik} , {y}_{jk} ) \qquad ( 5 )$$

It should be noted that, when eⁱ and e^{j} do not have a common related entity, n(eⁱ, e^{j}) may be set to a zero vector.

(3) Determine an embedding representation model based on the unary text embedding representation and the binary text embedding representation. The unary text embedding representation and the binary text embedding representation may be mapped, based on an existing knowledge graph embedding representation model, namely, a TransE model, to a same vector space to obtain a semantically enhanced unary text embedding representation and a semantically enhanced binary text embedding representation. The embedding representation model is established based on the semantically enhanced unary text embedding representation and the semantically enhanced binary text embedding representation. Because both an entity embedding representation and a relationship embedding representation are required in the embedding representation model, a modeling process can be described from a perspective of the fact triplet. For the known fact triplet [h, r, t] in the target knowledge graph, according to the foregoing two steps (1) and (2), unary text embedding representations n(h) and n(t) corresponding to h and t, and binary text embedding representation n(h,t) corresponding to h and t are obtained. Therefore, n(h), n(t) and n(h,t) are mapped according to the TransE model to obtain

ĥ=n(h)*A+h (6)

\hat{t}=n(t)*A+t (7)

\hat{r}=n(h,t)*B+r (8)

A and B are a predetermined entity mapping matrix and a predetermined relationship mapping matrix. h, t and r are model parameters corresponding to h, t, and r in the TransE model. ĥ and \hat{t} are receptively a semantically enhanced unary text embedding representation corresponding to n(h) and n(t), and \hat{r} is a semantically enhanced binary text embedding representation corresponding to n(h,t).

Then, a modeling idea of the TransE model may continue to be used. Based on ĥ, \hat{t} and \hat{r}, the embedding representation model of the target knowledge graph is modeled as

ƒ(h,t,r)=∥ĥ+\hat{r}−\hat{t}∥₂ (9)

To enhance the robustness of the entity/relationship embedding representation of the model, regularization constraints may be performed on components in the model, so that ∥h∥2≤1, ∥t∥2≤1, ∥r∥2≤1, ∥ĥ∥₂≤1, ∥\hat{t}∥₂≤1, ∥\hat{r}∥₂≤1, ∥n(h)*A∥₂≤1, ∥n(t)*A∥₂≤1, and ∥n(h,t)*B∥₂≤1. [symbol] represents a two-norm of [symbol] .

It should be noted that, as shown in formula (8), for different head entities h and/or tail entities t, \hat{r} has different representations. A loss function of the conventional TransE model is ƒ′(h,t,r)=∥h+r−t∥₂. Therefore, compared with the conventional TransE model, the embedding representation model shown in formula (9) provided in this embodiment can process a one-to-many, many-to-one, and many-to-many complex relationship. This is specifically because for different h and t, \hat{r} (that is, entity relationship) in ƒ(h,t,r) has different representations, while r in ƒ′(h,t,r) does not change with h and t. In addition to the TransE model, other frameworks of knowledge graph embedding representation models can be used, for example, TransR, TransH, and the like. TransE, TransR, and TransH are Trans series models. A basic idea of Trans series models is as follows: By continuously adjusting the model parameters h, t, and r corresponding to h, r, and t, h+r is as equal as possible to t, that is h+r≈t. However, multiple models have different loss functions (model function).

S305: Train the embedding representation model to obtain a second entity embedding representation of each entity and a relationship embedding representation of the entity relationship.

In a specific implementation, a loss function of the embedding representation model may be first determined. Based on a basic idea of the TransE model, the loss function of the embedding representation model shown in formula (9) provided in this embodiment may be determined as

L=Σ_{(h,r,t)∈S}Σ_{(h′,r′,t′)∈S′}max(0,ƒ(h,t,r)+λ−ƒ(h′,r′,t′)) (10)

λ is a hyperparameter greater than 0, S is a correct triplet set formed by a known fact triplet in the target knowledge graph, and S′ is an error triplet set formed by incorrect fact triplets that are manually constructed based on the known fact triplet. For example, [Secret, producer, Jiang Zhiqiang] is a known fact triplet. Then, the known fact triplet can be used to construct an incorrect fact triplet [Secret, producer, Jay Chou].

Then, the embedding representation model is trained, according to a preset training method, to minimize a function value of the loss function, to obtain the second entity embedding representation and the relationship embedding representation. The model may be trained by using, but not limited to, a gradient descent method. To be specific, to minimize the function value of the loss function, the model parameters h, t, and r are iteratively updated according to the gradient descent method until the function value of the loss function converges, or a quantity of iterative updates is greater than a preset quantity of times. Then, h and t obtained through the last update are used as entity embedding representation corresponding to h and t, and r is used as a relationship embedding representation corresponding to r.

In this embodiment, the M entities in the target knowledge graph are obtained. Then, the N related entities of the entity m in the M entities and K concepts corresponding to the related entity n in the N related entities are obtained from the preset knowledge base, where m=1, 2, 3, . . . , and M, n=1, 2, 3, . . . , and N. A semantic correlation between each of the M entities and each of the N related entities of the entity m, and a first entity embedding representation of each of the N related entities based on corresponding K concepts are determined. An embedding representation of the M entities and an embedding representation of an entity relationship between the M entities are modeled based on the first entity embedding representation and the semantic correlation, to obtain an embedding representation model. An embedding representation model is trained to obtain a second entity embedding representation of each entity and a relationship embedding representation of the entity relationship. Based on the TransE model, two-layer information fusion of the related entity, for example, entity—related entity—related entity of a related entity can be used to implement semantic extension embedding representation of the entity and the entity relationship. In this way, the finally obtained embedding representation model can effectively process the one-to-many, many-to-one, and many-to-many complex relationship.

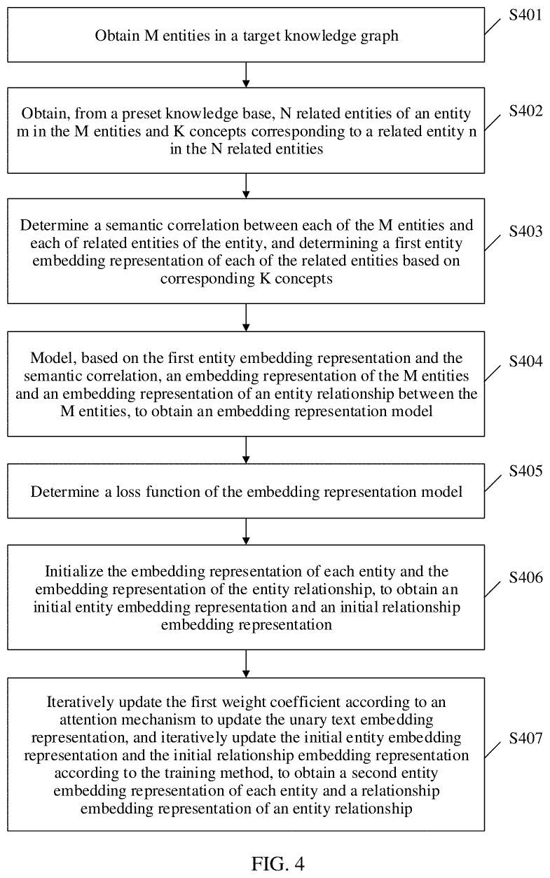

FIG. 4 is a schematic flowchart of a knowledge graph embedding representing method according to another embodiment of this application. The method includes but is not limited to the following steps.

S401: Obtain M entities in a target knowledge graph. This step is the same as S301 in the foregoing embodiment, and details are not described herein.

S402: Obtain, from a preset knowledge base, N related entities of an entity m in the M entities and K concepts corresponding to a related entity n in the N related entities. This step is the same as S302 in the foregoing embodiment, and details are not described herein.

S403: Determine a semantic correlation between each of the M entities and each of the N related entities of the entity, and determining a first entity embedding representation of each of the N related entities based on corresponding K concepts. This step is the same as S303 in the foregoing embodiment, and details are not described herein.

S404: Model, based on the first entity embedding representation and the semantic correlation, an embedding representation of the M entities and an embedding representation of an entity relationship between the M entities, to obtain an embedding representation model. This step is the same as S304 in the foregoing embodiment, and details are not described herein.

S405: Determine a loss function of the embedding representation model.

In a specific implementation, the loss function of the embedding representation model may be determined as a function shown in the formula (10). By combining formulas (6) to (9), it can be learned that a function value of the loss function is not only associated with the embedding representations h and t of the entities h and t and the embedding representation r of the entity relationship r in the target knowledge graph, but also associated with the unary text embedding representation n(h) and n(t), and the binary text embedding representation n(h,t) corresponding to h and t.

S406: Initialize the embedding representation of each entity and the embedding representation of the entity relationship, to obtain an initial entity embedding representation and an initial relationship embedding representation.

In a specific implementation, any initialization may be performed on, but not limited to, h, t, and r. For example, each dimension of h, t, and r may be randomly set to a value between 0 and 1. In addition, moduli of h, t, and r need to be normalized after the h, t, and r are initialized.

S407: Iteratively update the first weight coefficient according to an attention mechanism to update the unary text embedding representation, and iteratively update the initial entity embedding representation and the initial relationship embedding representation according to the training method, to obtain a second entity embedding representation of each entity and a relationship embedding representation of an entity relationship.

In a specific implementation, on one hand, that the iteratively update the first weight coefficient according to an attention mechanism to update the unary text embedding representation includes:

First, βᵢⱼ is calculated based on the first weight coefficient yᵢⱼ,

βᵢⱼ=φ*V*tan h(ω*μⱼⁱ+b)+(1−φ)*yᵢⱼ (11)

where tan h represents an arc tangent function. φ, V, b, and ω are all parameters learned by the attention mechanism. Then, the first weight coefficient is updated according to βᵢⱼ, to obtain an updated first weight coefficient αᵢⱼ,

$${α}_{ij} = \frac{exp ( {β}_{ij} )}{{\sum }_{j = 1}^{M} exp ( {β}_{ij} )} \qquad ( 12 )$$

In the formula (12), exp represents an exponential function with a natural constant e=2.71828 as a base.

In a process of training the embedding representation model, the attention mechanism is simultaneously executed to learn importance of each of the related entities in representing text content of a corresponding text, and a weight of each of the related entities in a unary text embedding representation of the corresponding text is updated according to a result of each learning, that is, update parameters φ, V, b, and ω in the formula (11). Therefore, the value of βᵢⱼ is continuously updated during model training, and therefore the value of αᵢⱼ is also continuously updated.

For example, related entities corresponding to the entity “Zhang Yimou” include “Coming Home” and “Hero”. Then, in an aligned text of “Zhang Yimou”, which mainly describes a realistic theme of director Zhang Yimou, it can be gradually learned according to the attention mechanism that a weight of “Coming Home” is greater than a weight of “Hero”.

On the other hand, an initial entity embedding representation of each entity and an initial relationship embedding representation of each entity relationship may be iteratively updated according to a preset model training method (such as a gradient descent method).

In conclusion, embedding representation model training is substantively: To minimize the function value of the loss function, continuously update the unary text embedding representation n(h), n(t), and the embedding representation h, t, and r of the entity and the entity relationship, until the loss function converges, or a quantity of times of iterative update is greater than a preset quantity of times. Then, h and t obtained through the last update are used as entity embedding representation corresponding to h and t, and r obtained through the last update is used as a relationship embedding representation corresponding to r.

Optionally, after the second entity embedding representation of each entity in the target knowledge graph and the relationship representation of each entity relationship are obtained, the knowledge graph may be completed based on the embedding representation. In other words, a new fact triplet is added to the knowledge graph. Specifically, the following steps may be included.

(1) Replace an entity relationship included in the known fact triplet in the target knowledge graph with another entity relationship included in the knowledge graph, or replace an entity included in the known fact triplet with another entity included in the knowledge graph, to obtain a predicted fact triplet.

For example, as shown in FIG. 1, the knowledge graph includes a known fact triplet [Jay Zhou, nationality, Han nationality], and the entity “Jay Zhou” may be replaced with another entity “Jiang Zhiqiang” in the knowledge graph, to obtain a predicted fact triplet [Jiang Zhiqiang, nationality, Han nationality]. Similarly, “Han nationality” can also be replaced with “Taiwan” to obtain another predicted fact triplet [Jay Zhou, nationality, Taiwan].

(2) Determine a recommended score of the predicted fact triplet based on a second entity embedding representation of an entity in the predicted fact triplet and a relationship embedding representation of the entity relationship, where the recommended score may be used to measure prediction accuracy of each predicted fact triplet, and may also be considered as a probability that the predicted fact triplet is an actually established fact triplet. A model function (for example, formula (9)) of an entity/entity relationship embedding representation model may be used as a score function of the model. Then, the second entity embedding representation of the entity in the predicted fact triplet and the relationship embedding representation of the entity relationship are substituted into the score function for calculation. The recommended score of the predicted fact triplet is determined based on a function value obtained through calculation. In the TransE framework, because a distance between ĥ+\hat{r} and \hat{t} of an incorrect fact triplet is longer than that of a correct fact triplet, a function value obtained by substituting the incorrect fact triplet into the score function ƒ(h,t,r)=∥ĥ+\hat{r}−\hat{t}∥₂ for calculation is greater than that of the correct fact triplet. In this case, to satisfy general recommendation logic, a difference obtained by subtracting a function value of ƒ(h,t,r) from a preset highest recommendation score, that is, a full score (for example, 1 point, 10 points, or 100 points) of the recommendation score may be used as the recommendation score.

(3) Add, based on the recommended score, the predicted fact triplet to the target knowledge graph. A recommended score of each predicted fact triplet may be compared with a preset threshold, and a predicted fact triplet whose recommended score is greater than the preset threshold may be added to the target knowledge graph. The preset threshold may be 0.8, 8, 80, or the like.

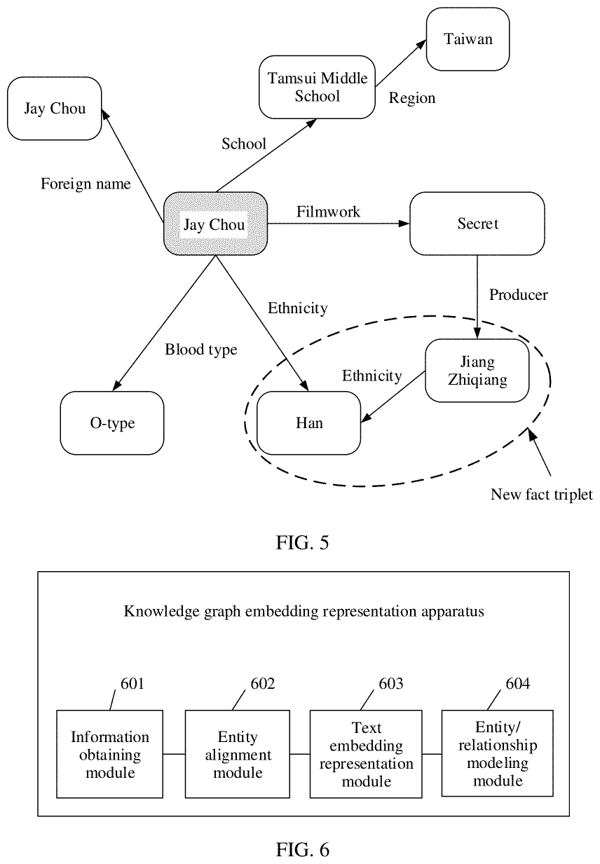

For example, for the knowledge graph shown in FIG. 1, recommended scores of predicted fact triplets [Jiang Zhiqiang, nationality, Han nationality] and [Jay Zhou, nationality, Taiwan] obtained based on a score function ƒ(h,t,r)=∥ĥ+\hat{r}−\hat{t}∥₂ are 0.85 and 0.34. Because 0.85 is greater than 0.8 and 0.34 is less than 0.8, [Jiang Zhiqiang, nationality, Han nationality] is added to the knowledge graph, to obtain a completed knowledge graph shown in FIG. 5. As shown in the figure, before the completion, there is no relationship between the entities “Jiang Zhiqiang” and “Han nationality” in the target knowledge graph. Through the entity/relationship embedding representation, it can be inferred that there is an entity relationship “nationality” between “Jiang Zhiqiang” and “Han nationality”. In other words, through the entity/relationship embedding representation, implicit entity relationship in the knowledge graph can be inferred in addition to existing entity relationship.

Optionally, a plurality of predicted fact triplets may be first sorted based on recommended scores, and the plurality of predicted fact triplets may, but is not limited to, be sorted in descending order of the recommended scores. Then, the top Q predicted fact triplets are added to the target knowledge graph, where Q is an integer not less than 1. An actual size of Q may be determined based on a total quantity of the predicted fact triplets. For example, if the total quantity of the predicted fact triplets is 10, Q=10×20%=2.

In this embodiment, the M entities in the target knowledge graph are obtained. Then, the N related entities of the entity m in the M entities and the K concepts corresponding to the related entity n in the N related entities are obtained from the preset knowledge base, where m=1, 2, 3, . . . , and M, n=1, 2, 3, . . . , and N. The semantic correlation between each of the M entities and each of the N related entities of the entity m, and the first entity embedding representation of each of the N related entities based on corresponding K concepts are determined. The embedding representation of the M entities and the embedding representation of the entity relationship between the M entities are modeled based on the first entity embedding representation and the semantic correlation, to obtain the embedding representation model. The first weight coefficient is iteratively updated according to the attention mechanism to update the unary text embedding representation, and an entity embedding representation and an entity relationship embedding representation are iteratively updated according to the preset model training method to train the embedding representation model, to obtain the second entity embedding representation of each entity and the relationship embedding representation of the entity relationship. The attention mechanism can further improve a capability of capturing a related entity feature in the aligned text, and further improve entity/relationship embedding representation effect, and improve the accuracy and comprehensiveness of completion of the target knowledge graph.

FIG. 6 is a schematic structural diagram of a knowledge graph embedding representing apparatus according to an embodiment of this application. As shown in the figure, the apparatus in this embodiment includes:

an information obtaining module 601, configured to obtain M entities in a target knowledge graph, where the M entities include an entity 1, an entity 2, . . . , and an entity M, and M is an integer greater than 1;

an entity alignment module 602, configured to obtain, from a preset knowledge base, N related entities of an entity m in the M entities and K concepts corresponding to a related entity n in the N related entities, where the N related entities include a related entity 1, a related entity 2, . . . , and a related entity N, N and K are integers not less than 1, m=1, 2, 3, . . . , and M, n=1, 2, 3, . . . , and N, the entity m is semantically correlated with the N related entities, and the related entity n is semantically correlated with the K concepts;

a text embedding representation module 603, configured to determine a semantic correlation between each of the M entities and each of the N related entities of the entity m, and determine a first entity embedding representation of each of the N related entities based on corresponding K concepts;

an entity/relationship modeling module 604, configured to model, based on the first entity embedding representation and the semantic correlation, an embedding representation of the M entities and an embedding representation of an entity relationship between the M entities, to obtain an embedding representation model; and

the entity/relationship modeling module 604 is further configured to train the embedding representation model to obtain a second entity embedding representation of each entity and a relationship embedding representation of the entity relationship.

Optionally, the text embedding representation module 603 is further configured to perform vectorization processing on each concept in the K concepts corresponding to the related entity n, to obtain a word vector of each concept, and perform average summation on word vectors of the K concepts, to obtain a first entity embedding representation of the related entity n.

Optionally, the entity/relationship modeling module 604 is further configured to determine, based on the semantic correlation and a first entity embedding representation of the N related entities, a unary text embedding representation corresponding to each entity. A common related entity of every two entities in the M entities is determined based on the N related entities. A binary text embedding representation corresponding to the every two entities is determined based on the semantic correlation and a first entity embedding representation of the common related entity. The embedding representation model is established based on the unary text embedding representation and the binary text embedding representation.

Optionally, the entity/relationship modeling module 604 is further configured to map the unary text embedding representation and the binary text embedding representation to a same vector space to obtain a semantically enhanced unary text embedding representation and a semantically enhanced binary text embedding representation. The embedding representation model is established based on the semantically enhanced unary text embedding representation and the semantically enhanced binary text embedding representation.

Optionally, the entity/relationship modeling module 604 is further configured to use the semantic correlation as a first weight coefficient of each of the related entities. In addition, weighted summation is performed, based on the first weight coefficient, on the first entity embedding representation of the N related entities, to obtain the unary text embedding representation.

Optionally, the entity/relationship modeling module 604 is further configured to use the common related entity and a minimum semantic correlation of semantic correlations of every two entities as a second weight coefficient of the common related entity. Weighted summation is performed, based on the second weight coefficient, on the first entity embedding representation of the common related entity, to obtain a binary text embedding representation.

Optionally, the entity/relationship modeling module 604 is further configured to determine a loss function of the embedding representation model. The embedding representation model is trained, according to a preset training method, to minimize a function value of the loss function, to obtain the second entity embedding representation and the relationship embedding representation.

The function value is associated with an embedding representation of each entity, an embedding representation of the entity relationship, and the unary text embedding representation.

Optionally, the entity/relationship modeling module 604 is further configured to initialize the embedding representation of each entity and the embedding representation of the entity relationship, to obtain an initial entity embedding representation and an initial relationship embedding representation.

Optionally, the knowledge graph embedding representation apparatus in this embodiment further includes an attention calculation module, configured to iteratively update the first weight coefficient according to an attention mechanism to update the unary text embedding representation.

The entity/relationship modeling module 604 is further configured to iteratively update, based on an updated unary text embedding representation, the initial entity embedding representation and the initial relationship embedding representation according to the training method.

The target knowledge graph includes a known fact triplet, and the known fact triplet includes two entities in the M entities and an entity relationship.

The knowledge graph embedding representation apparatus in this embodiment further includes a graph completion module, configured to replace an entity relationship included in the known fact triplet with another entity relationship between the N entities, or replace one entity included in the known fact triplet with another entity in the N entities, to obtain a predicted fact triplet. A recommended score of the predicted fact triplet is determined based on a second entity embedding representation of an entity in the predicted fact triplet and a relationship embedding representation of the entity relationship. Then, the predicted fact triplet is added to the target knowledge graph according to the recommended score.

It should be noted that, for implementation of each module, refer to corresponding descriptions of the method embodiments shown in FIG. 3 and FIG. 4. The module performs the methods and the functions performed by the knowledge graph embedding representation apparatus in the foregoing embodiments.

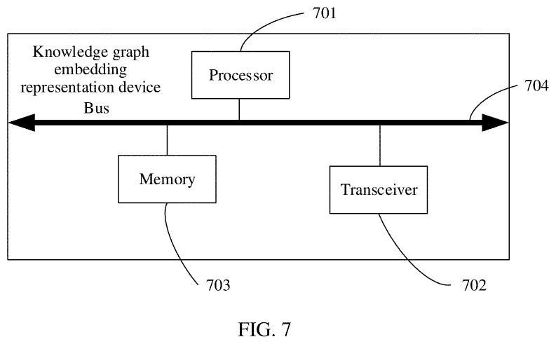

FIG. 7 is a schematic structural diagram of a knowledge graph embedding representing device according to an embodiment of this application. As shown in the figure, the embedding representation device of the knowledge graph may include at least one processor 701, at least one transceiver 702, at least one memory 703, and at least one communications bus 704. Alternatively, in some implementations, the processor and the memory may be integrated.

The processor 701 may be a central processing unit, a general-purpose processor, a digital signal processor, an application-specific integrated circuit, a field programmable gate array or another programmable logic device, a transistor logic device, a hardware component, or any combination thereof. The processor may implement or execute various example logical blocks, modules, and circuits described with reference to content disclosed in this application. Alternatively, the processor may be a combination of processors implementing a computing function, for example, a combination of one or more microprocessors, or a combination of the digital signal processor and a microprocessor. The communications bus 704 may be a peripheral component interconnect (PCI) bus, an extended industry standard architecture (EISA) bus, or the like. The bus may be classified into an address bus, a data bus, a control bus, and the like. For ease of representation, only one thick line is used to represent the bus in FIG. 7, but this does not mean that there is only one bus or only one type of bus. The communications bus 704 is configured to implement connection and communication between these components. The transceiver 702 in the device in this embodiment is configured to communicate with another network element. The memory 703 may include a volatile memory, for example, a nonvolatile dynamic random access memory (NVRAM), a phase change random access memory (PRAM), or a magnetoresistive random access memory (Magnetoresistive RAM, MRAM). The memory 703 may further include a nonvolatile memory, for example, at least one magnetic disk storage device, an electrically erasable programmable read-only memory (EEPROM), a flash storage device, for example, a NOR flash memory or a NAND flash memory, or a semiconductor device, for example, a solid-state drive (Solid State Disk, SSD). Optionally, the memory 703 may be at least one storage apparatus that is far away from the processor 701. The memory 703 stores a group of program code, and optionally, the processor 701 may further execute a program stored in the memory 703 to perform the following operations:

obtaining M entities in a target knowledge graph, where the M entities comprise an entity 1, an entity 2, . . . , and an entity M, and M is an integer greater than 1;

obtaining, from a preset knowledge base, N related entities of an entity m in the M entities and K concepts corresponding to a related entity n in the N related entities, where the N related entities comprise a related entity 1, a related entity 2, . . . , and a related entity N, N and K are integers not less than 1, m=1, 2, 3, . . . , and M, n=1, 2, 3, . . . , and N, the entity m is semantically correlated with the N related entities, and the related entity n is semantically correlated with the K concepts;

determining a semantic correlation between each of the M entities and each of the N related entities of the entity m, and determining a first entity embedding representation of each of the N related entities based on corresponding K concepts;

modeling, based on the first entity embedding representation and the semantic correlation, an embedding representation of the M entities and an embedding representation of an entity relationship between the M entities, to obtain an embedding representation model; and

training the embedding representation model to obtain a second entity embedding representation of each entity and a relationship embedding representation of the entity relationship.

Optionally, the processor 701 is further configured to:

perform vectorization processing on each concept in the K concepts corresponding to the related entity n, to obtain a word vector of each concept; and

perform average summation on word vectors of the K concepts corresponding to the related entity n, to obtain a first entity embedding representation of the related entity n.

Optionally, the processor 701 is further configured to:

determine, based on the semantic correlation and a first entity embedding representation of the N related entities, a unary text embedding representation corresponding to each entity;

determine, based on the N related entities, a common related entity of every two entities in the M entities;

determine, based on the semantic correlation and a first entity embedding representation of the common related entity, a binary text embedding representation corresponding to the every two entities; and

determine, based on the unary text embedding representation and the binary text embedding representation, the embedding representation model.

Optionally, the processor 701 is further configured to:

map the unary text embedding representation and the binary text embedding representation to a same vector space to obtain a semantically enhanced unary text embedding representation and a semantically enhanced binary text embedding representation; and

establish, based on the semantically enhanced unary text embedding representation and the semantically enhanced binary text embedding representation, the embedding representation model.

Optionally, the processor 701 is further configured to:

use the semantic correlation as a first weight coefficient of each of the N related entities; and

perform, based on the first weight coefficient, weighted summation on the first entity embedding representation of the N related entities, to obtain the unary text embedding representation.

Optionally, the processor 701 is further configured to:

use the common related entity and a minimum semantic correlation of semantic correlations of every two entities as a second weight coefficient of the common related entity; and

perform, based on the second weight coefficient, weighted summation on the first entity embedding representation of the common related entity, to obtain the binary text embedding representation.

Optionally, the processor 701 is further configured to:

determine a loss function of the embedding representation model; and

train, according to a preset training method, the embedding representation model to minimize a function value of the loss function, to obtain the second entity embedding representation and the relationship embedding representation.

Optionally, the function value is associated with an embedding representation of each entity, an embedding representation of the entity relationship, and the unary text embedding representation;

The processor 701 is further configured to:

initialize the embedding representation of each entity and the embedding representation of the entity relationship, to obtain an initial entity embedding representation and an initial relationship embedding representation;

update the first weight coefficient according to an attention mechanism to update the unary text embedding representation, and iteratively update the initial entity embedding representation and the initial relationship embedding representation according to the training method.

Optionally, the target knowledge graph includes a known fact triplet, and the known fact triplet includes two entities in the M entities and an entity relationship;

The processor 701 is further configured to:

replace the entity relationship comprised in the known fact triplet with another entity relationship between the N entities, or replace one entity comprised in the known fact triplet with another entity in the N entities, to obtain a predicted fact triplet;

determine a recommended score of the predicted fact triplet based on a second entity embedding representation of an entity in the predicted fact triplet and a relationship embedding representation of the entity relationship; and

add, based on the recommended score, the predicted fact triplet to the target knowledge graph.

Further, the processor may further cooperate with the memory and the transceiver to perform operations of the knowledge graph embedding representation apparatus in the foregoing embodiments of this application.

All or some of the foregoing embodiments may be implemented by using software, hardware, firmware, or any combination thereof. When software is used to implement the embodiments, the embodiments may be implemented completely or partially in a form of a computer program product. The computer program product includes one or more computer instructions. When the computer program instructions are loaded and executed on the computer, the procedure or functions according to the embodiments of this application are all or partially generated. The computer may be a general-purpose computer, a dedicated computer, a computer network, or other programmable base stations. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid-state drive (Solid State Disk, SSD)), or the like.

The objectives, technical solutions, and beneficial effects of this application are further described in detail in the foregoing non-limiting examples of specific implementations. Any modification, equivalent replacement, or improvement made without departing from the principle of this application shall fall within the protection scope of this application.

1. A knowledge graph embedding representation method, comprising:
obtaining M entities in a target knowledge graph, wherein the M entities comprise an entity 1, an entity 2, . . . , and an entity M, and M is an integer greater than 1;
obtaining, from a preset knowledge base, N related entities of an entity m in the M entities and K concepts corresponding to a related entity n in the N related entities, wherein the N related entities comprise a related entity 1, a related entity 2, . . . , and a related entity N, N and K are integers not less than 1, m=1, 2, 3, . . . , and M, n=1, 2, 3, . . . , and N, the entity m is semantically correlated with the N related entities, and the related entity n is semantically correlated with the K concepts;
determining a semantic correlation between each of the M entities and each of the N related entities of the entity m, and determining a first entity embedding representation of each of the N related entities based on corresponding K concepts;
modeling, based on the first entity embedding representation and the semantic correlation, an embedding representation of the M entities and an embedding representation of an entity relationship between the M entities, to obtain an embedding representation model; and
training the embedding representation model to obtain a second entity embedding representation of each entity and a relationship embedding representation of the entity relationship.

2. The method according to claim 1, wherein the determining a first entity embedding representation of each of the N related entities based on corresponding K concepts comprises:
performing vectorization on each concept in the K concepts corresponding to the related entity n, to obtain a word vector of each concept; and
performing average summation on word vectors of the K concepts corresponding to the related entity n, to obtain a first entity embedding representation of the related entity n.

3. The method according to claim 1, wherein the modeling, based on the first entity embedding representation and the semantic correlation, an embedding representation of the M entities and an embedding representation of an entity relationship between the M entities, to obtain an embedding representation model comprises:
determining, based on the semantic correlation and a first entity embedding representation of the N related entities, a unary text embedding representation corresponding to each entity;
determining, based on the N related entities, a common related entity of every two entities in the M entities;
determining, based on the semantic correlation and a first entity embedding representation of the common related entity, a binary text embedding representation corresponding to the every two entities; and
establishing, based on the unary text embedding representation and the binary text embedding representation, the embedding representation model.

4. The method according to claim 3, wherein the establishing, based on the unary text embedding representation and the binary text embedding representation, the embedding representation model comprises:
mapping the unary text embedding representation and the binary text embedding representation to a same vector space, to obtain a semantically enhanced unary text embedding representation and a semantically enhanced binary text embedding representation; and
establishing, based on the semantically enhanced unary text embedding representation and the semantically enhanced binary text embedding representation, the embedding representation model.

5. The method according to claim 3, wherein the determining, based on the semantic correlation and a first entity embedding representation of the N related entities, a unary text embedding representation corresponding to each entity comprises:
using the semantic correlation as a first weight coefficient of each of the N related entities; and
performing, based on the first weight coefficient, weighted summation on the first entity embedding representation of the N related entities, to obtain the unary text embedding representation.

6. The method according to claim 3, wherein the determining, based on the semantic correlation and a first entity embedding representation of the common related entity, a binary text embedding representation corresponding to the every two entities comprises:
using the common related entity and a minimum semantic correlation of semantic correlations of every two entities as a second weight coefficient of the common related entity; and
performing, based on the second weight coefficient, weighted summation on the first entity embedding representation of the common related entity, to obtain the binary text embedding representation.

7. The method according to claim 5, wherein the training the embedding representation model to obtain a second entity embedding representation of each entity and a relationship embedding representation of the entity relationship comprises:
determining a loss function of the embedding representation model; and
training, according to a preset training method, the embedding representation model to minimize a function value of the loss function, to obtain the second entity embedding representation and the relationship embedding representation.

8. The method according to claim 7, wherein the function value is associated with an embedding representation of each entity, an embedding representation of the entity relationship, and a unary text embedding representation;
the training, according to a preset training method, the embedding representation model to minimize a function value of the loss function, to obtain the second entity embedding representation and the relationship embedding comprises:
initializing the embedding representation of each entity and the embedding representation of the entity relationship, to obtain an initial entity embedding representation and an initial relationship embedding representation; and
iteratively updating the first weight coefficient according to an attention mechanism to update the unary text embedding representation, and iteratively updating the initial entity embedding representation and the initial relationship embedding representation according to the training method.

9. The method according to claim 1, wherein the target knowledge graph comprises a known fact triplet, and the known fact triplet comprises two entities in the M entities and an entity relationship;
the training the embedding representation model to obtain a second entity embedding representation of each entity and a relationship embedding representation of the entity relationship comprises:
replacing the entity relationship comprised in the known fact triplet with another entity relationship between the M entities, or replacing one entity comprised in the known fact triplet with another entity in the M entities, to obtain a predicted fact triplet;
determining a recommended score of the predicted fact triplet based on a second entity embedding representation of an entity in the predicted fact triplet and a relationship embedding representation of the entity relationship; and
adding, based on the recommended score, the predicted fact triplet to the target knowledge graph.

10. An apparatus for knowledge graph embedding representation, comprising:
at least one processor; and
one or more memories coupled to the at least one processor and storing executable program instructions that, when executed by the at least one processor, cause the at least one processor to:
obtain M entities in a target knowledge graph, wherein the M entities comprise an entity 1, an entity 2, . . . , and an entity M, and M is an integer greater than 1;
obtain, from a preset knowledge base, N related entities of an entity m in the M entities and K concepts corresponding to a related entity n in the N related entities, wherein the N related entities comprise a related entity 1, a related entity 2, . . . , and a related entity N, N and K are integers not less than 1, m=1, 2, 3, . . . , and M, n=1, 2, 3, . . . , and N, the entity m is semantically correlated with the N related entities, and the related entity n is semantically correlated with the K concepts;
determine a semantic correlation between each of the M entities and each of the N related entities of the entity m, and determining a first entity embedding representation of each of the N related entities based on corresponding K concepts;
model, based on the first entity embedding representation and the semantic correlation, an embedding representation of the M entities and an embedding representation of an entity relationship between the M entities, to obtain an embedding representation model; and
train the embedding representation model to obtain a second entity embedding representation of each entity and a relationship embedding representation of the entity relationship.

11. The apparatus according to claim 10, wherein the determining a first entity embedding representation of each of the N related entities based on corresponding K concepts comprises:
performing vectorization on each concept in the K concepts corresponding to the related entity n, to obtain a word vector of each concept; and
performing average summation on word vectors of the K concepts corresponding to the related entity n, to obtain a first entity embedding representation of the related entity n.

12. The apparatus according to claim 10, wherein the modeling, based on the first entity embedding representation and the semantic correlation, an embedding representation of the M entities and an embedding representation of an entity relationship between the M entities, to obtain an embedding representation model comprises:
determining, based on the semantic correlation and a first entity embedding representation of the N related entities, a unary text embedding representation corresponding to each entity;
determining, based on the N related entities, a common related entity of every two entities in the M entities;
determining, based on the semantic correlation and a first entity embedding representation of the common related entity, a binary text embedding representation corresponding to the every two entities; and
establishing, based on the unary text embedding representation and the binary text embedding representation, the embedding representation model.

13. The apparatus according to claim 12, wherein the establishing, based on the unary text embedding representation and the binary text embedding representation, the embedding representation model comprises:
mapping the unary text embedding representation and the binary text embedding representation to a same vector space, to obtain a semantically enhanced unary text embedding representation and a semantically enhanced binary text embedding representation; and
establishing, based on the semantically enhanced unary text embedding representation and the semantically enhanced binary text embedding representation, the embedding representation model.

14. The apparatus according to claim 12, wherein the determining, based on the semantic correlation and a first entity embedding representation of the N related entities, a unary text embedding representation corresponding to each entity comprises:
using the semantic correlation as a first weight coefficient of each of the N related entities; and
performing, based on the first weight coefficient, weighted summation on the first entity embedding representation of the N related entities, to obtain the unary text embedding representation.

15. The apparatus according to claim 13, wherein the determining, based on the semantic correlation and a first entity embedding representation of the common related entity, a binary text embedding representation corresponding to the every two entities; comprises:
using the common related entity and a minimum semantic correlation of semantic correlations of every two entities as a second weight coefficient of the common related entity; and
performing, based on the second weight coefficient, weighted summation on the first entity embedding representation of the common related entity, to obtain the binary text embedding representation.

16. A computer-readable storage medium storing a program, wherein the program comprises instructions that, when executed by a computer, cause the computer to perform operations comprising:
obtaining M entities in a target knowledge graph, wherein the M entities comprise an entity 1, an entity 2, . . . , and an entity M, and M is an integer greater than 1;
obtaining, from a preset knowledge base, N related entities of an entity m in the M entities and K concepts corresponding to a related entity n in the N related entities, wherein the N related entities comprise a related entity 1, a related entity 2, . . . , and a related entity N, N and K are integers not less than 1, m=1, 2, 3, . . . , and M, n=1, 2, 3, . . . , and N, the entity m is semantically correlated with the N related entities, and the related entity n is semantically correlated with the K concepts;
determining a semantic correlation between each of the M entities and each of the N related entities of the entity m, and determining a first entity embedding representation of each of the N related entities based on corresponding K concepts;
modeling, based on the first entity embedding representation and the semantic correlation, an embedding representation of the M entities and an embedding representation of an entity relationship between the M entities, to obtain an embedding representation model; and
training the embedding representation model to obtain a second entity embedding representation of each entity and a relationship embedding representation of the entity relationship.

17. The computer-readable storage medium according to claim 16, wherein the determining a first entity embedding representation of each of the N related entities based on corresponding K concepts comprises:
performing vectorization on each concept in the K concepts corresponding to the related entity n, to obtain a word vector of each concept; and
performing average summation on word vectors of the K concepts corresponding to the related entity n, to obtain a first entity embedding representation of the related entity n.

18. The computer-readable storage medium according to claim 16, wherein the modeling, based on the first entity embedding representation and the semantic correlation, an embedding representation of the M entities and an embedding representation of an entity relationship between the M entities, to obtain an embedding representation model comprises:
determining, based on the semantic correlation and a first entity embedding representation of the N related entities, a unary text embedding representation corresponding to each entity;
determining, based on the N related entities, a common related entity of every two entities in the M entities;
determining, based on the semantic correlation and a first entity embedding representation of the common related entity, a binary text embedding representation corresponding to the every two entities; and
establishing, based on the unary text embedding representation and the binary text embedding representation, the embedding representation model.

19. The computer-readable storage medium according to claim 18, wherein the establishing, based on the unary text embedding representation and the binary text embedding representation, the embedding representation model comprises:
mapping the unary text embedding representation and the binary text embedding representation to a same vector space, to obtain a semantically enhanced unary text embedding representation and a semantically enhanced binary text embedding representation; and
establishing, based on the semantically enhanced unary text embedding representation and the semantically enhanced binary text embedding representation, the embedding representation model.

20. The computer-readable storage medium according to claim 18, wherein the determining, based on the semantic correlation and a first entity embedding representation of the N related entities, a unary text embedding representation corresponding to each entity comprises:
using the semantic correlation as a first weight coefficient of each of the N related entities; and
performing, based on the first weight coefficient, weighted summation on the first entity embedding representation of the N related entities, to obtain the unary text embedding representation.
